(19) United States
(12) Patent Application Publication
(10) Pub. No.: US 2026/0261440 A1
(43) Pub. Date: Sep. 3, 2026

(54) Excess-Entropy Utilization in FM-Based Physical Unclonable Functions for Post-Quantum Authentication

(71) Applicant: Maurice Nobert, Cleveland Hts, OH (US)

(72) Inventor: Maurice Nobert, Cleveland Hts, OH (US)

(21) Appl. No.: 19/339,865

(22) Filed: Sep. 25, 2025

(51) Int. Cl. H04L 9/32; H04L 9/06

(52) U.S. Cl. CPC H04L 9/3278; H04L 9/0631

(57) ABSTRACT

An FM-based physical unclonable function (PUF) system is provided configured to harvest excess entropy from ambient radio-frequency (RF) environments to support post-quantum secure authentication. The system employs multi-dimensional signal features including received signal strength indicator (RSSI) and signal-to-noise ratio (SNR) values extracted from frequency-modulated (FM) signals. Challenge-response pairs (CRPs) are generated by selecting subsets of features across multiple temporal slots. Error correction coding (ECC) is applied to stabilize noisy responses, enabling reliable generation of entropy exceeding 256 bits per sub-vector. The architecture supports federated authentication across distributed devices and can be integrated with post-quantum cryptographic schemes. Applications include authentication of unmanned aerial vehicles, electric vehicles, financial transactions, and zero-trust architectures. By pooling entropy across nodes, the system achieves resilience against machine learning and quantum attacks while supporting one-time pad encryption and post-quantum key exchange.

### CROSS REFERENCE TO RELATED APPLICATION

There are no previously filed, nor currently any co-pending applications, anywhere in the world.

### BACKGROUND OF THE INVENTION

Conventional PUFs often face challenges in entropy sufficiency, reliability, and resilience against machine learning attacks. There exists a need for a robust entropy-harvesting architecture leveraging ambient radio-frequency environments.

### SUMMARY OF THE INVENTION

The disclosure provides an FM-based physical unclonable function system configured to derive multi-dimensional feature vectors from ambient FM signals, stabilize responses using ECC, and expand entropy beyond 256 bits per sub-vector. The architecture supports excess entropy pooling, one-time pad generation, and integration with post-quantum cryptography.

### BRIEF DESCRIPTION OF DRAWINGS

The advantages and features of the present invention will become better understood with reference to the following more detailed description and claims taken in conjunction with the accompanying drawings, in which like elements are identified with like symbols, and in which:

FIG. 1 illustrates an FM PUF system block diagram.

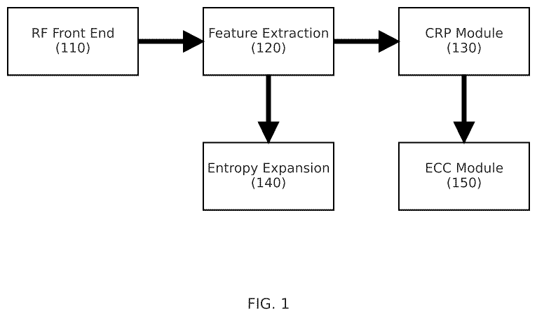

FIG. 2 illustrates feature vector selection and CRP generation.

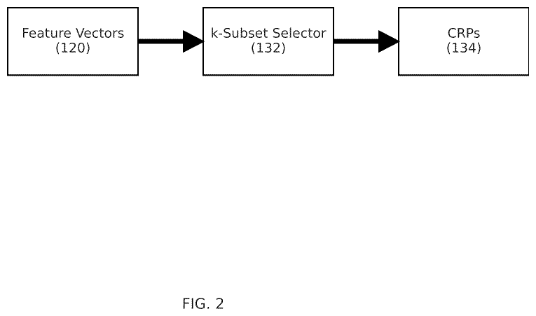

FIG. 3 illustrates ECC stabilization.

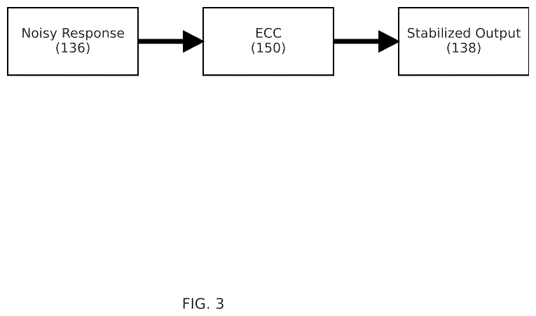

FIG. 4 illustrates entropy composition from signal variability and CRP permutations.

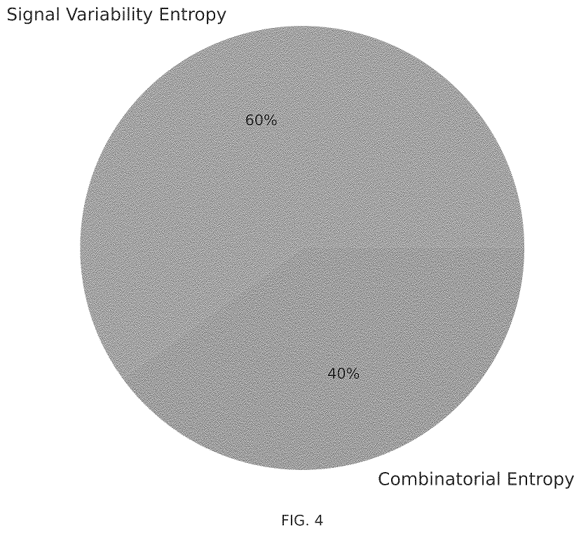

FIG. 5 illustrates application scenarios.

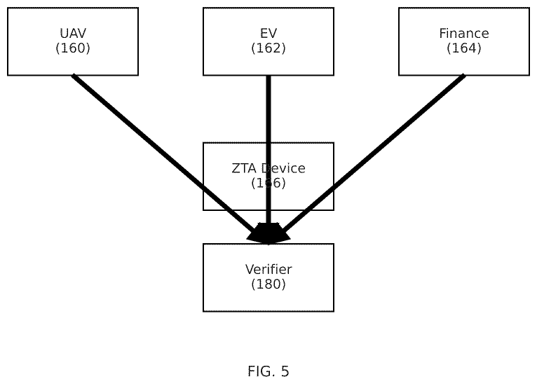

### DETAILED DESCRIPTION OF THE INVENTION

The best mode for carrying out the invention is presented in terms of its preferred embodiment, herein depicted within the Figures. It should be understood that the legal scope of the description is defined by the words of the claims set forth at the end of this patent and that the detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

The FM PUF comprises a radio-frequency front end, feature extraction module, challenge-response module, entropy expansion engine, and ECC stabilization unit. Multi-dimensional vectors, including RSSI, SNR, and Doppler spread, are segmented into subsets across time slots to form CRPs. Error correction, such as Reed-Solomon or LDPC, corrects noise variability while preserving uniqueness. System-level architectures allow federated authentication across UAVs, EVs, financial systems, and ZTA environments. Entropy may exceed 700 bits in urban deployments and 250 bits in rural deployments, ensuring resilience against post-quantum adversaries.

The foregoing descriptions of specific embodiments of the present invention are presented for purposes of illustration and description. The Title, Background, Summary, Brief Description of the Drawings and Abstract of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples and the various features are grouped together in various embodiments for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the Detailed Description, with each claim standing on its own as a separately claimed subject matter.

The claims are not intended to be limited to the aspects described herein, but is to be accorded the full scope consistent with the language claims and to encompass all legal equivalents. Notwithstanding, none of the claims are intended to embrace subject matter that fails to satisfy the requirement of 35 U.S.C. § 101, 102, or 103, nor should they be interpreted in such a way. Any unintended embracement of such subject matter is hereby disclaimed. They are not intended to be exhaustive nor to limit the invention to precise forms disclosed and, obviously, many modifications and variations are possible in light of the above teaching. The embodiments are chosen and described in order to best explain principles of the invention and its practical application, to thereby enable others skilled in the art to best utilize the invention and its various embodiments with various modifications as are suited to the particular use contemplated. It is intended that a scope of the invention be defined broadly by the Drawings and Specification appended hereto and to their equivalents. Therefore, the scope of the invention is in no way to be limited only by any adverse inference under the rulings of Warner-Jenkinson Company, v. Hilton Davis Chemical, 520 US 17 (1997) or Festo Corp. v. Shoketsu Kinzoku Kogyo Kabushiki Co., 535 U.S. 722(2002), or other similar caselaw or subsequent precedent should not be made if any future claims are added or amended subsequent to this Patent Application.

1-30. canceled

31. A physical unclonable function (PUF) system comprising:
a radio-frequency front end configured to receive ambient frequency-modulated (FM) signals across a plurality of channels;
a feature extraction module configured to derive multi-dimensional signal feature vectors from the FM signals, the features including at least received signal strength indicator (RSSI) values and signal-to-noise ratio (SNR) values;
a challenge-response module configured to generate challenge-response pairs (CRPs) by selecting k-subsets of the feature vectors across temporal slots; and an entropy expansion module configured to output entropy exceeding 256 bits.

32. The system of claim 1 wherein the entropy expansion module is configured to generate one-time pad keys exceeding 256 bits for secure message encryption and decryption between a device and a verifier.

33. The system of claim 1 wherein the CRPs are integrated with post-quantum cryptographic schemes including lattice-based cryptography, code-based cryptography, or symmetric algorithms such as AES-256.

34. The system of claim 1 wherein the CRPs are applied to device authentication in at least one of: unmanned aerial vehicles (UAVs), electric vehicles (EVs), financial transaction systems, or zero-trust network architectures.

35. The system of claim 1 wherein the feature vectors further include Doppler spread values.

36. The system of claim 1 wherein entropy is derived from both signal variability and combinatorial CRP permutations.

37. The system of claim 1 wherein geographic variability contributes at least 20 percent of total entropy.

38. A method of generating authentication responses comprising:
receiving FM signals across a plurality of channels; extracting RSSI and SNR features to form multi-dimensional feature vectors;
generating CRPs by selecting k-subsets of the feature vectors across temporal slots;
applying error correction coding (ECC) to the CRPs; and outputting entropy exceeding 256 bits for authentication or cryptographic use.

39. The system of claim 38 wherein the ECC comprises Reed-Solomon coding.

40. The system of claim 38 wherein the ECC comprises low-density parity-check (LDPC) coding.

41. The system of claim 38 wherein the ECC reduces error rate below 10\hat{ }-9 across a 1,000 km geographic separation.

42. A method of enhancing post-quantum resilience comprising pooling entropy outputs from multiple FM PUF devices, applying ECC, and integrating the pooled entropy into a post-quantum cryptographic scheme.

43. The system of claim 42 wherein the one-time pad keys are refreshed at sub-second intervals.

44. The system of claim 42 wherein the one-time pad keys exceed 512 bits in length.
